(19) United States
(12) Patent Application Publication
(10) Pub. No.: US 2006/0178763 A1
(43) Pub. Date: Aug. 10, 2006

(54) Positioning apparatus and method of controlling positioning apparatus

(75) Inventors: Taizan Kobayashi, Kawasaki (JP); Eiji Takada, Kawasaki (JP); Kazumi Suto, Kawasaki (JP)

Correspondence Address: ARENT FOX PLLC, 1050 CONNECTICUT AVENUE, N.W., SUITE 400, WASHINGTON, DC, 20036, US

(73) Assignee: FUJITSU LIMITED

(21) Appl. No.: 11/136,543

(22) Filed: May 25, 2005

(30) Foreign Application Priority Data
Feb. 4, 2005 (JP) 2005-029378

(51) Int. Cl. G05B 19/18

(52) U.S. Cl. 700/56

(57) ABSTRACT

A movable member moves along a predetermined guide path. A supporting member extends from the movable member. A processing unit is fixed to the tip end of the supporting member. A sensor detects the movement of the movable member. When the movable member has stopped moving, the processing unit is subjected to a transient due to the inertia acting on the processing unit. The transient is detected based on the waveform of the sensor signal. The position of the processing unit can thus precisely be detected based on the sensor signal. The time for starting the operation of the processing unit can optimally be determined. The processing unit is thus allowed to start operating at the determined time. The processing unit is allowed to start operating in a shorter time after the movable member has stopped moving, even when the transient remains in the processing unit.

### BACKGROUND OF THE INVENTION

1. Field of the Invention

The present invention relates to a positioning apparatus incorporated in a processing or working apparatus such as a chip mounter designed to mount an electronic component chip on a printed circuit board. The present invention also relates to a method of controlling the same.

2. Description of the Prior Art

As disclosed in Japanese Patent Application Publication No. 2003-124112, for example, an exposure apparatus is often utilized in a fine processing of a wafer. An optical unit, a mask, and the like are aligned to a wafer placed on a work table in the exposure apparatus. The work table is moved in the horizontal direction so as to position the optical unit and the mask, for example. Transient remains in the work table after the work table has stopped moving. The optical unit and the mask are driven to move in synchronization with the transient. The optical unit and the mask can be aligned with the wafer without an error. The positional deviation can be canceled. A precise alignment can be achieved even during the transient of the work table.

The exposure apparatus of the type requires a large mechanism to drive the optical unit and the mask in synchronization with the transient of the work table. The exposure apparatus is also forced to have a complicated structure. One must face an increased cost of manufacturing the exposure apparatus.

### SUMMARY OF THE INVENTION

It is an object of the present invention to provide a positioning apparatus and a method of controlling the same optimally determining a time for starting operation of a processing unit with a simple structure.

According to a first aspect of the present invention, there is provided a positioning apparatus comprising: a movable member designed to move along a predetermined guide path; a supporting member extending from the movable member; a processing unit fixed to the tip end of the supporting member; a sensor detecting the movement of the movable member; a controller circuit designed to determine a time point for starting the operation of the processing unit based on a sensor signal, the sensor signal output from the sensor when the movable member has stopped moving.

When the movable member has stopped moving, the processing unit is subjected to a transient due to the inertia acting on the processing unit. The transient of the processing unit is detected based on the waveform of the sensor signal. The position of the processing unit can thus precisely be detected based on the sensor signal. The controller circuit is allowed to optimally determine the time for starting the operation of the processing unit. The processing unit is thus allowed to start operating at the determined time. The processing unit is allowed to start operating in a shorter time after the movable member has stopped moving, even when the transient remains in the processing unit.

Furthermore, the positioning apparatus allows utilization of a sensor designed to detect the movement of the movable member. The sensor is employed to position the movable member. Accordingly, the present invention can be applied to a conventional positioning apparatus in a facilitated manner. The time for starting the operation of the processing unit can be determined with a simple structure. The determination of the starting time thus fails to require a larger mechanism or additional components. One can thus enjoy a reduction in the cost of manufacturing the positioning apparatus. The controller circuit may determine the time based on a period of the sensor signal in the positioning apparatus.

The processing unit may include an exposure apparatus. As described above, the positioning apparatus enables a precise positioning in a shorter time even during a transient. The processing unit can be positioned relative to an object with a higher accuracy. The exposure apparatus is allowed to effect exposure at the best position during the transient.

According to a second aspect of the present invention, there is provided a method of controlling a positioning apparatus, the method comprising: monitoring a waveform of a sensor signal output from a sensor when a movable member has stopped moving, said sensor designed to detect the movement of the movable member moving along a predetermined guide path; and determining a time for starting the operation of a processing unit based on the waveform, said processing unit supported on the movable member.

When the movable member has stopped moving, the processing unit is subjected to a transient due to the inertia acting on the processing unit. The transient of the processing unit can be detected based on the waveform of the sensor signal. The position of the processing unit can thus precisely be detected based on the sensor signal. It is possible to determine the optimum position for the operation of the processing unit. The time for starting the operation of the processing unit is in this manner determined. The processing unit is allowed to start operating in a shorter time after the movable member has stopped moving, even when the transient remains in the processing unit. The time may be determined based on a period of the waveform.

### BRIEF DESCRIPTION OF THE DRAWINGS

The above and other objects, features and advantages of the present invention will become apparent from the following description of the preferred embodiments in conjunction with the accompanying drawings, wherein:

FIG. 1 is a perspective view schematically illustrating the structure of a chip mounter according to an embodiment of the present invention;

FIG. 2 is a sectional view schematically illustrating a state of a camera unit and a movable member during a transient;

FIG. 3 is a graph schematically illustrating a waveform derived from a pulse signal;

FIG. 4 is a perspective view schematically illustrating the structure of a chip mounter according to a modification of the present invention;

FIG. 5 is a graph schematically illustrating a waveform derived from a pulse signal; and

FIG. 6 is a perspective view schematically illustrating the structure of a chip mounter according to another modification of the present invention.

### DESCRIPTION OF THE PREFERRED EMBODIMENTS

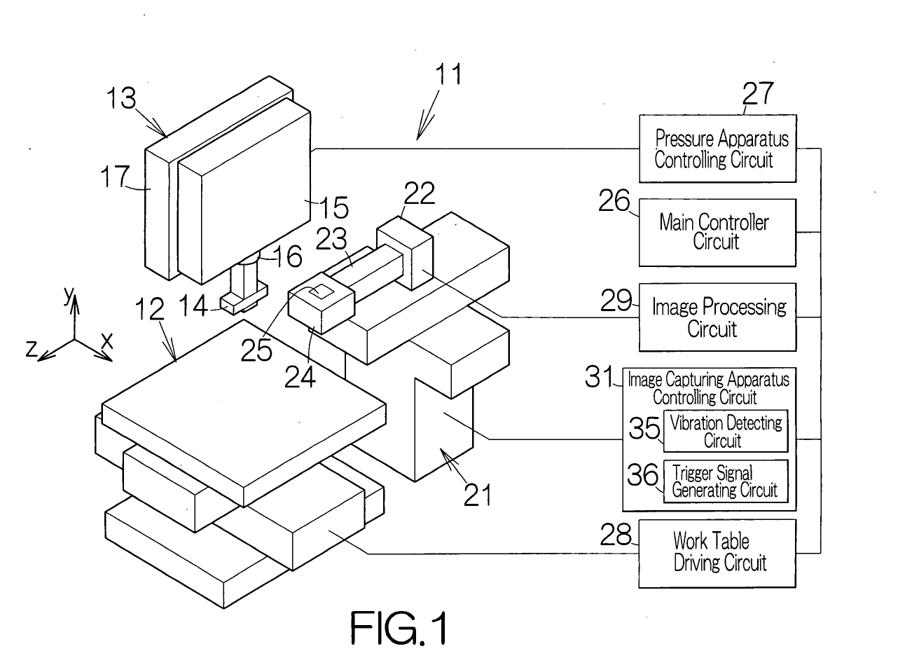

FIG. 1 schematically illustrates a chip mounter 11 as an example of a processing apparatus according to an embodiment of the present invention. The chip mounter 11 includes a work table 12 defining the upper flat surface along a predetermined horizontal plane. The work table 12 is allowed to move within the horizontal plane. The work table 12 is designed to receive a printed circuit board on the upper flat surface.

Here, the xyz-coordinate system is established in the chip mounter 11. The y-axis of the xyz-coordinate system extends in the direction perpendicular to the upper flat surface of the work table 12, namely to the horizontal plane. The work table 12 is driven in the directions of the x-axis and the y-axis. The position of the work table 12 can be identified with the x-coordinate and the y-coordinate.

A pressure apparatus 13 is related to the work table 12. The pressure apparatus 13 includes an ultrasonic head 14. The ultrasonic head 14 is designed to hold a circuit component chip at the lower end opposed to the upper flat surface of the work table 12. An ultrasonic oscillator is incorporated within the ultrasonic head 14 so as to generate an ultrasonic vibration. The ultrasonic is transmitted from the ultrasonic oscillator to the chip. The ultrasonic serves to induce the vibration of the ultrasonic head 14 in the horizontal direction, for example.

The ultrasonic head 14 is allowed to move in the direction perpendicular to the upper flat surface of the work table 12 along the y-axis of the xyz-coordinate system, as described later. The perpendicular movement of the ultrasonic head 14 is employed to urge the chip to a printed circuit board on the upper flat surface of the work table 12. The ultrasonic is transmitted to the chip in this situation. The ultrasonic head 14 thus realizes ultrasonic bonding based on the ultrasonic vibration of the ultrasonic head 14.

The pressure apparatus 13 includes a moving member 15 coupled to the ultrasonic head 14. A force sensor 16 is interposed between the ultrasonic head 14 and the moving member 15. The force sensor 16 is designed to detect a force or load acting on the ultrasonic head 14 in the direction of the y-axis. The force sensor 16 converts the detected load to an electric signal. Strain gauges may be incorporated within the force sensor 16. The force sensor 16 detects a tension load or a compression load.

The pressure apparatus 13 further includes a support member 17. The support member 17 is designed to support the moving member 15. The support member 17 stands stationary during the movement of the moving member 15. Specifically, the ultrasonic head 14, the moving member 15 and the force sensor 16 are allowed to move relative to the support member 17. A driving source, such as a voice coil motor, VCM, is coupled to the moving member 15. The voice coil motor serves to generate a driving force to drive the moving member 15. The voice coil motor induces the perpendicular movement of the ultrasonic head 14 and the force sensor 16.

An image capturing apparatus 21 is related to the work table 12 and the pressure apparatus 13. The image capturing apparatus 21 includes a movable member 22 designed to move along a predetermined guide path. The predetermined guide path is defined in parallel with the z-axis. The movable member 22 is thus allowed to move along a horizontal plane relative to the work table 12 in the direction of the z-axis. The image capturing apparatus 21 includes a supporting member 23 extending from the movable member 22 along the z-axis.

A processing unit, such as a camera unit 24 is fixed to the tip end of the supporting member 23. An exposure mechanism, such as an image capturing mechanism 25 is incorporated within the camera unit 24. The image capturing mechanism 25 may employ a CCD, charge-coupled device, for example. When the movable member 22 moves in the horizontal direction, the image capturing mechanism 25 can be positioned in a space between the ultrasonic head 14 and the top surface of the work table 12. The image capturing mechanism 25 is in this manner capable of simultaneously capture an image of the electronic circuit chip held on the ultrasonic head 14 and an image of the printed circuit board placed on the top surface of the work table 12.

The chip mounter 11 includes a main controller circuit 26. The main controller circuit 26 controls the operation of the chip mounter 11 in accordance with the implementation of a predetermined software program. The main controller circuit 26 supplies a predetermined electric signal to an ultrasonic oscillator installed within the ultrasonic head 14. Ultrasonic vibration is induced in the ultrasonic head 14 based on the supplied electric signal.

A pressure apparatus controlling circuit 27 is connected to the main controller circuit 26. The pressure apparatus controlling circuit 27 is allowed to supply the voice coil motor with electric current in accordance with the implementation of a predetermined software program. The perpendicular movement of the moving member 15 is induced based on the supplied electric current. The ultrasonic head 14 is in this manner moved along the y-axis in the perpendicular direction perpendicular to the top surface of the work table 12. The pressure apparatus controlling circuit 27 is allowed to control the thrust of the ultrasonic head 14.

A work table driving circuit 28 is also connected to the main controller circuit 26. The work table driving circuit 28 is designed to supply a predetermined electric signal to an electric motor incorporated within the work table 12, for example. The work table driving circuit 28 may receive a predetermined control signal from the main controller circuit 26 in supplying the electric signal to the work table 12. The work table 12 is allowed to move in the horizontal direction along the x-axis or the z-axis based on the supplied electric signal.

An image processing circuit 29 is connected to the main controller circuit 26. The image processing circuit 29 is designed to supply the image capturing mechanism 25 with a predetermined control signal. The image capturing mechanism 25 is allowed to capture an image of the printed circuit board and an image of the electronic circuit chip in response to the supply of the control signal. The image processing circuit 29 processes and analyzes the image output from the image capturing mechanism 25. A trigger signal is supplied to the image processing circuit 29 from a trigger signal generating circuit in supplying the control signal. The trigger signal generating circuit will be described later in detail.

An image capturing apparatus controlling circuit 31 is connected to the main controller circuit 26. The image capturing apparatus controlling circuit 31 is designed to supply a predetermined electric signal to an electric motor incorporated within the image capturing apparatus 21, for example. The image capturing apparatus controlling circuit 31 receives a predetermined control signal from the main controller circuit 26 in supplying the electric signal to the image capturing apparatus 21. The movable member 22 is allowed to move in the horizontal direction along the z-axis based in response to the supply of the electric signal.

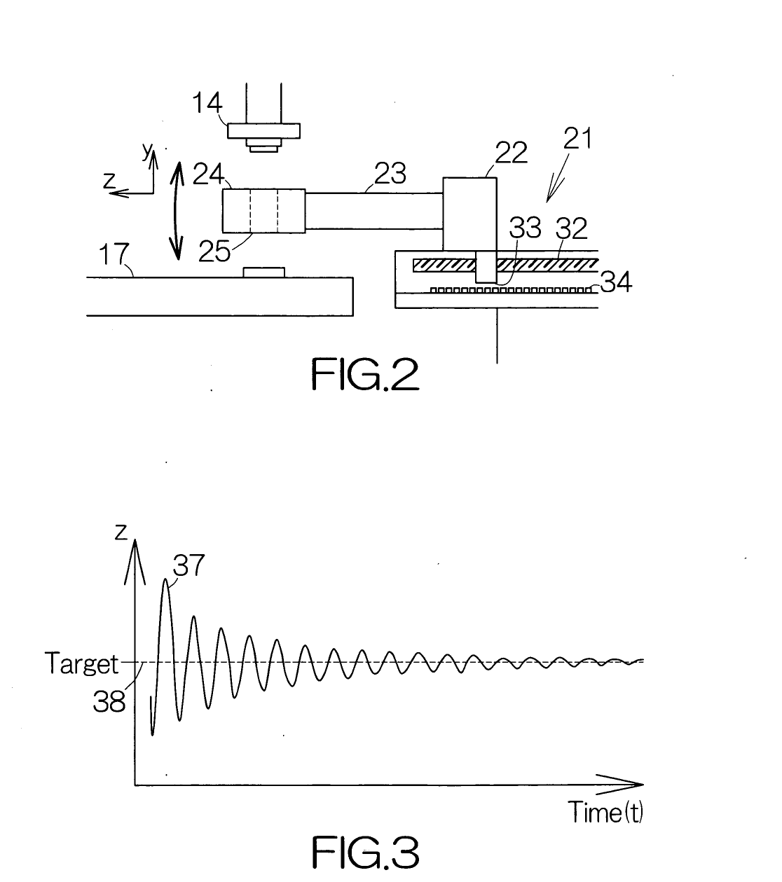

Referring also to FIG. 2, the movable member 22 is connected to a ball screw 32 for the aforementioned horizontal movement, for example. The ball screw 32 extends along the z-axis. A motor incorporated within the image capturing apparatus 21 serves to drive the ball screw 32 for rotation. The rotation of the ball screw 32 causes the horizontal movement of the movable member 22.

A position sensor 33 is attached to the movable member 22. The position sensor 33 is electrically connected to the image capturing apparatus controlling circuit 31. The position sensor 33 employs a pulse encoder, for example. The position sensor 33 is opposed to fine protrusions or pieces 34 arranged at minute intervals. When the movable member 22 moves in the horizontal direction, the position sensor 33 generates a pulse signal based on the arrangement of the fine pieces 34. The pulse signal is supplied to the image capturing apparatus controlling circuit 31. The pulses in the pulse signal are counted for detecting the amount of movement for the movable member 22. The image capturing apparatus controlling circuit 31 in this manner determines the position of the movable member 22.

The image capturing apparatus controlling circuit 31 includes a vibration detecting circuit 35. The vibration detecting circuit 35 is designed to detect vibration of the movable member 22 and the camera unit 24. When the movable member 22 and the camera unit 24 vibrate, the position sensor 33 supplies the vibration detecting circuit 35 with the pulse signal. The pulse signal is converted into a waveform signal at the vibration detecting circuit 35. The vibration detecting circuit 35 analyzes the waveform signal. The vibration detecting circuit 35 determines a time for starting the operation of the camera unit 24, namely the starting time for capturing, based on the waveform signal. The starting time can in this manner be set. A detail description will be made later on the determination of the starting time.

The image capturing apparatus controlling circuit 31 includes a trigger signal generating circuit 36. The trigger signal generating circuit 36 is designed to generate a trigger signal based on the starting time determined at the vibration detecting circuit 35. The generated trigger signal is delivered to the image processing circuit 29. The image processing circuit 29 supplies the control signal to the image capturing mechanism 25 in response to the supply of the trigger signal. The image capturing mechanism 25 thus starts capturing an image at the set starting time. Note that the movable member 22, the supporting member 23, the camera unit 24, the position sensor 33 and the image capturing apparatus controlling circuit 31 in combination serve as a positioning apparatus according to the present invention.

Now, assume that an electronic circuit chip is to be bonded to a printed circuit board. The printed circuit board is placed on the top surface of the work table 12. The chip is set on the ultrasonic head 14. The chip has been made to have ball bumps on the lower surface. The ball bumps may be made of a conductive material such as copper. A positioning mark is established on the lower surface of the chip. A positioning mark is also established on the upper surface of the printed circuit board so as to indicate a position receiving the chip. The ultrasonic head 14 is first positioned at a first position. The ultrasonic head 14 at the first position is distanced from the surface of the work table 12 by a predetermined distance.

The main controller circuit 26 then supplies the control signal to the image capturing apparatus controlling circuit 31. The image capturing apparatus controlling circuit 31 supplies the electric signal to the electric motor within the image capturing apparatus 21 based on the control signal. The movable member 22 thus moves in the horizontal direction along the z-axis toward the work table 12. The movable member 22 is thereafter positioned at a predetermined target position based on the detection of the position sensor 33. The camera unit 24 is thus positioned in a space between the chip and the printed circuit board. When the movable member 22 has stopped moving, the movable member 22, the supporting member 23 and the camera unit 24 are subjected to a transient due to the inertia thereafter. As is apparent from FIG. 2, the camera unit 24 swings along with the movable member 22 and the supporting member 23 within the yz-plane.

The position sensor 33 outputs the pulse signal to the vibration detecting circuit 35 based on the transient remaining in the movable member 22. The output pulse signal is converted into a corresponding waveform signal 37 at the vibration detecting circuit 35, as shown in FIG. 3. The waveform signal gets attenuated. Since the transient of the camera unit 24 converges at the set target position, the target position can be the datum or a centerline 38 for the measurement of the amplitude of the waveform signal 37. Accordingly, the time point of the intersection of the waveform signal 37 across the centerline 38 corresponds to the time point when the camera unit 24 is exactly positioned at the target position. The intersection across the centerline 38 corresponds to the time optimum to capture an image with the image capturing mechanism 25.

Next, the vibration detecting circuit 35 calculates a period for the vibration of the camera unit 24. The period is determined constant based on the natural frequency of the movable member 22, the supporting member 23 and the camera unit 24. If a time interval can be determined between the consecutive intersections on the centerline 38, future intersections can be predicted. The starting time for capturing an image can thus be determined based on the predicted intersections. The trigger signal generating circuit 36 outputs the trigger signal to the image processing circuit 29 in response to the determination of the starting time. The image processing circuit 29 supplies the control signal to the image capturing mechanism 25 in response to the supply of the trigger signal. The image capturing mechanism 25 thus captures the images of the chip and the printed circuit board. The required images are in this manner captured based on the starting time.

The captured images are supplied to the image processing circuit 29. The image processing circuit 29 detects the position of the positioning marks on the chip and the printed circuit board. The detected positions are subsequently converted into position signals. The position signals are then supplied to the main controller circuit 26. The main controller circuit 26 calculates the amount of displacement between the positioning marks of the chip and of the printed circuit board based on the position signals. The main controller circuit 26 then calculates the amount of adjustment for the movement of the work table 12 based on the calculated amount of displacement.

The main controller circuit 26 supplies the control signal to the work table driving circuit 28 based on the calculated amount of adjustment. The work table driving circuit 28 supplies the work table 12 with the electric signal in accordance with the control signal. The work table 12 thus moves in the horizontal direction based on the calculated amount of adjustment. The positioning mark of the printed circuit board is aligned with the positioning mark of the chip. The chip is in this manner correctly aligned with the printed circuit board. The image capturing apparatus 21 is thereafter withdrawn from a space above the work table 12 based on the horizontal movement of the movable member 22.

Next, the main controller circuit 26 supplies the control signal to the pressure apparatus controlling circuit 27. The pressure apparatus controlling circuit 27 supplies the voice coil motor with electric current based on the control signal. The perpendicular movement of the ultrasonic head 14 is controlled based on the supply of the electric current. The ultrasonic head 14 moves downward toward the top surface of the work table 12. The ultrasonic head 14 is positioned at a second position. The ultrasonic head 14 is distanced from the printed circuit board by a predetermined distance.

The ultrasonic head 14 further moves downward from the second position. The ultrasonic head 14 thus urges the chip against the printed circuit board. The ball bumps on the chip are forced to contact with the corresponding conductive pads on the printed circuit board. The conductive pads may be made of an electrically conductive material such as copper, for example. When the chip is urged against the printed circuit board, the ultrasonic head 14 lifts up the force sensor 16 in parallel with the y-axis. Strain is induced in the strain gauges. The strain gauges get deformed, so that electric resistance is changed. The change in the electric resistance is converted into an electric signal. The electric signal is then supplied to the pressure apparatus controlling circuit 27 from the force sensor 16. The pressure apparatus controlling circuit 27 detects the load based on the electric signal. The pressure apparatus controlling circuit 27 supplies the voice coil motor with electric current based on the detected load. This causes the ultrasonic head 14 to move in the perpendicular direction. The load or thrust of the ultrasonic head 14 depends on the physical property of the chip and the printed circuit board, for example.

The main controller circuit 26 then supplies the ultrasonic head 14 with an electric signal. The supply of the electric signal causes the ultrasonic oscillator to generate ultrasonic vibration. The ultrasonic vibration is transmitted to the ultrasonic head 14 in the horizontal direction. The ultrasonic vibration of the ball bumps is thus induced. Plastic deformation is induced at contacts between the ball bumps and the conductive pads based on the ultrasonic energy. Oxide films are broken at the contacts between the ball bumps and the conductive pads. Exchanged metallic atoms diffuse into the ball bumps and the conductive pads. The ball bumps are in this manner bonded to the corresponding conductive pads. A so-called ultrasonic bonding is achieved.

The pressure controller circuit 27 then supplies the voice coil motor with electric current. The ultrasonic head 14 thus moves upward. The ultrasonic head 14 is allowed to reach the first position through the second position. The printed circuit board is displaced from the work table 12 along with the chip. A printed circuit board and a chip are thereafter set on the work table 12 and the ultrasonic head 14 again. The chip mounter repeats the aforementioned processes. These processes are executed in three seconds, for example, after the set of the printed circuit board and chip to the accomplishment of the ultrasonic bonding.

The camera unit 24 suffers from a transient due to the inertia acting on the camera unit 24 in the aforementioned chip mounter 11 when the movable member 22 has stopped moving. The inventors has revealed that the transient of the camera unit 24 can be detected in the pulse signal or waveform signal 37 output from the position sensor 33. The period of the transient can be determined based on the waveform signal 37. The derived period of the transient can be utilized to determine the starting time for capturing an image at the image capturing mechanism 25. The displacement can be canceled between the image capturing mechanism 25 and the printed circuit board as well as between the image capturing mechanism 25 and the chip prior to the convergence or completion of the transient. The recognition of images is allowed to enjoy an improved accuracy. The image capturing mechanism 25 is allowed to start capturing an image as soon as the movable member 22 has stopped moving, even when the transient remains in the camera unit 24.

The position sensor 33 designed to detect the movement of the movable member 22 can be utilized to detect the waveform signal 37. The position sensor 33 is a common component in a conventional chip mounter. The present invention can thus easily be applied to the conventional chip mounter. A simple structure can be employed to determine the starting time. The determination of the starting time thus fails to require a larger mechanism or additional components. One can enjoy a reduction in the cost of manufacturing the image capturing apparatus 21, i.e., the chip mounter 11. In particular, a conventional chip mounter requires a large mechanism to synchronize the movement of the pressure apparatus and the work table with the transient of the movable member or the camera unit. The structure thus get complicated in the conventional chip mounter. The conventional chip mounter suffers from an increased cost of manufacturing. On the other hand, the chip mounter 11 of the present invention allows an accurate detection of a transient based on the pulse signal from the position sensor 33, so that the optimum position can be determined for capturing an image even during the transient of the camera unit 24. Accordingly, the present invention can in particular be applied to a processing apparatus of a simplified structure in an effective manner.

The peak-to-peak value of the waveform signal 37 can be utilized to calculate the period for the vibration of the camera unit 24. The peak-to-peak value is defined by the maximum and minimum values of the amplitude. Since the period of the vibration is constant, the peak-to-peak value can be detected at constant intervals. The time period between a maximum point and the intersection across the centerline 38 is equal to the time period between a minimum point and the intersection in the waveform signal 37, so that the time point of the intersection across the centerline 38 can easily be derived. If the time period can in this manner be obtained between the consecutive intersections, the time point can be predicted for the future intersections. The starting time can be determined based on the predicted time points. The mentioned processes may be effected at the vibration detecting circuit 35.

Otherwise, the count of pulses in the signal from the position sensor 33 can be utilized to calculate the period for the vibration of the camera unit 24. The count of pulses repetitiously increases and decreases relative to the number of pulses corresponding to the target position when the camera unit 24 swings due to the transient. The amount of the increment and decrement is reduced as the vibration attenuates. Since the period for the vibration is constant as described above, the increase and decrease in the count of pulses are repeated in a constant period. Accordingly, the time can be predicted for the count of pulses indicating the target position. The predicted time is set as the starting time. The mentioned processes may be effected at the vibration detecting circuit 35.

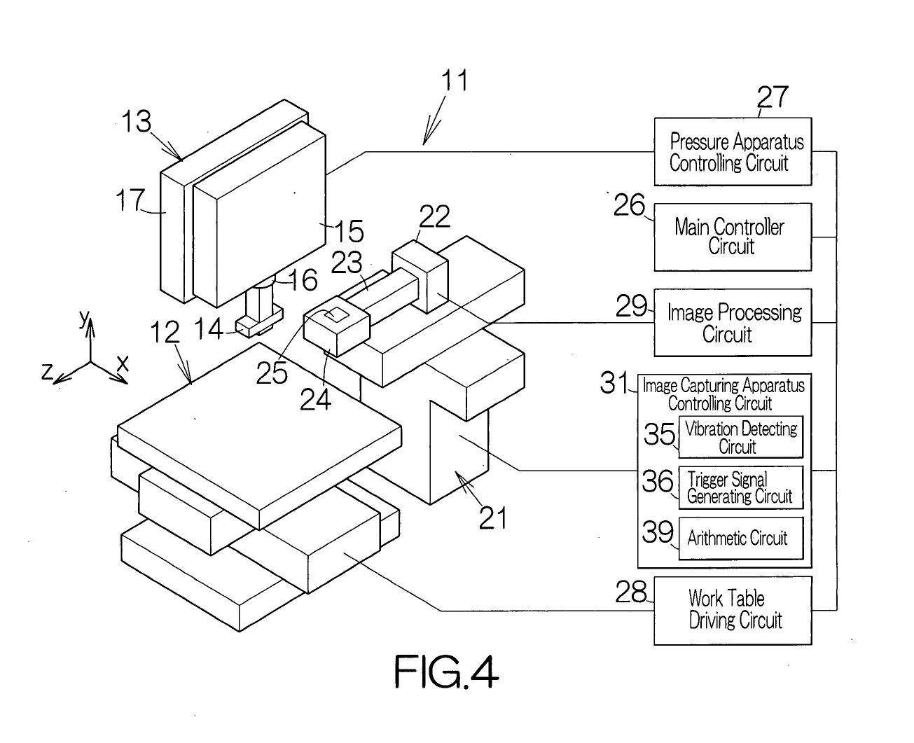

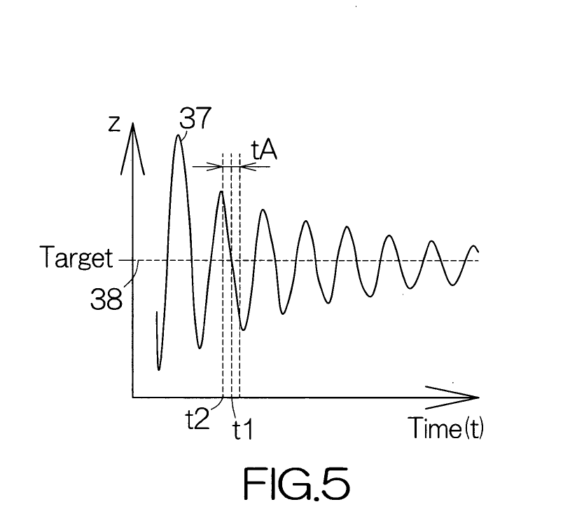

Otherwise, the starting time can be determined based on the exposure time of the image capturing mechanism 25. As shown in FIG. 4, the image capturing apparatus controlling circuit 31 may further include an arithmetic circuit 39. The arithmetic circuit 39 may be designed to determine the starting time for capturing an image based on the exposure time of the image capturing mechanism 25. The vibration detecting circuit 35 converts the pulse signal into the waveform signal 37. Referring also to FIG. 5, the vibration detecting circuit 35 predicts the time point [tA] of the intersection between the waveform signal 37 and the centerline 38 in the same manner as described above. The arithmetic circuit 39 calculates the time point [t2] based on the exposure time period [tA]. The time point [t2] corresponds to half the exposure time period [tA] before the predicted time point [t1]. The time point [t2] thus corresponds to the starting time. The trigger signal is supplied to the image processing circuit 29 at the starting time, i.e., the time [t2]. The required images are in this manner captured based on the starting time. The accuracy of the image recognition can further be improved.

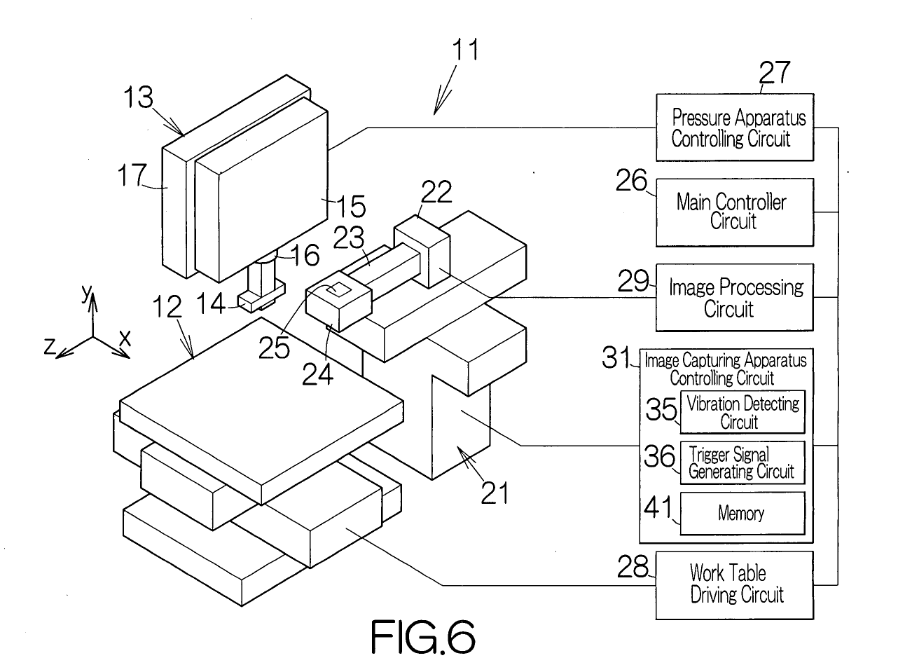

Otherwise, the starting time for capturing an image can be determined based on the comparison of the waveform signal with a reference waveform. The pulse signal indicating the transient is converted into a waveform signal in the manner as described above in forming the reference waveform. The image capturing apparatus controlling circuit 31 may include a memory 41 holding the converted waveform signal serving as the reference waveform, as shown in FIG. 6. The aforementioned centerline is established on the reference waveform. The vibration detecting circuit 35 compares the waveform signal with the reference waveform to determine the starting time. The vibration detecting circuit 35 observes the correspondence between the waveform signal and the reference waveform. When the waveform signal accords with the reference waveform, the waveform signal can be predicted based on the reference waveform. The time points of the intersections can thus be derived from the predicted waveform signal. The starting time is determined based on the time points of the predicted intersections. In this case, the aforementioned calculation is not required in the processes of comparing the waveform signal with the reference signal. The starting time can accordingly be set in a shorter time.

The starting time can be determined based on the implementation of a predetermined software program at the image capturing apparatus controlling circuit 31 in the chip mounter 11. In this case, the image capturing apparatus controlling circuit 31 may include, for example, a central processing unit, CPU, a random access memory, RAM, and a memory circuit such as a non-volatile memory. The software program may be stored in the non-volatile memory. The CPU temporarily transfers the programs from the non-volatile memory to the RAM.

What is claimed is:

1. A positioning apparatus comprising:
a movable member designed to move along a predetermined guide path;
a supporting member extending from the movable member;
a processing unit fixed to a tip end of the supporting member;
a sensor detecting movement of the movable member;
a controller circuit designed to determine a time for starting operation of the processing unit based on a sensor signal, said sensor signal output from the sensor when the movable member has stopped moving.

2. The positioning apparatus according to claim 1, wherein the controller circuit determines the time based on a period of the sensor signal.

3. The positioning apparatus according to claim 1, wherein the processing unit includes an exposure mechanism.

4. A method of controlling a positioning apparatus, the method comprising:
monitoring a waveform of a sensor signal output from a sensor when a movable member has stopped moving, said sensor designed to detect movement of the movable member moving along a predetermined guide path; and
determining a time for starting operation of a processing unit based on the waveform, said processing unit supported on the movable member.

5. The method according to claim 4, wherein the time is determined based on a period of the waveform.
